(19) United States
(12) Patent Application Publication
(10) Pub. No.: US 2007/0258864 A1
(43) Pub. Date: Nov. 8, 2007

(54) Methods and devices for concentration and fractionation of analytes for chemical analysis

(75) Inventors: Ryan Braymer, Clifton Park, NY (US); Floria Cheng, San Francisco, CA (US); Eric Claude, Vienna, VA (US); Jeffrey Cameron Loper, Alexandria, VA (US); Craig Mauch, Clifton Park, NY (US); Ralph Paul, Alexandria, VA (US); Ron Wilson, Scotia, NY (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Protein Discovery, Inc.

(21) Appl. No.: 11/636,412

(22) Filed: Dec. 8, 2006

Related U.S. Application Data
(60) Provisional application No. 60/748,771, filed on Dec. 8, 2005.

(51) Int. Cl. B01L 3/00; B01L 11/00

(52) U.S. Cl. 422/102; 422/99

(57) ABSTRACT

A multi-well cassette configuration and an instrument capable of accepting the cassette and thereafter pre-concentrating and purifying analytes from biological samples held in the cassette wells, such as human serum, for subsequent analysis by Matrix-Assisted Laser Desorption Ionization Mass Spectrometry (MALDI MS).

### CROSS-REFERENCE

This application claims priority to Provisional Application Ser. No. 60/748,771, filed Dec. 8, 2005.

### BACKGROUND OF THE INVENTION

1. Field of the Invention

The present invention relates to Mass Spectrometry (MS) and, more specifically, to pre-concentration and purification of analytes from biological samples, such as human serum, to be analyzed by Matrix-Assisted Laser Desorption Ionization Mass Spectrometry (MALDI MS).

2. State of the Art

Mass spectrometry allows multiple analytes to be monitored simultaneously, in contrast to most other analytical techniques that quantify only one, or at most, just a few different molecules at a time. Recent advances in mass spectrometry; such as lower cost instrumentation, improved ease of use, and high throughput MALDI methods; promise to revolutionize clinical research, and then as a result the entire healthcare industry. A key to realizing this tremendous potential, however, is the development of new sample preparation technologies capable of preparing complex biological samples for mass spectrographic analysis rapidly and reproducibly. Such technologies need to accommodate a wide variety of samples including solids including tissue homogenates, whole tissue slices or other solid tissue preparations, as well as liquid samples such as whole blood, plasma, serum, cerebrospinal fluid, saliva, urine and the like. Serum is perhaps the most clinically important biological fluid, with hundreds of millions of samples taken by vacuum tube yearly for medical diagnoses. Blood and lymphatic fluids are rich sources of disease biomarkers because, in addition to natural blood-borne proteins & polypeptides circulating in blood and lymph fluids, body tissues release additional cellular components into the blood and lymph streams. Thus these circulating fluids contain disease biomarkers including proteins & polypeptides (PP) that are indicative of pathological conditions, such as cellular hyperplasia, necrosis, apoptosis, or shedding of antigens from neoplastic tissue. Here the term PP is used to refer to oligopeptides or proteins of broad molecular weight range including the range of from two, or more, amino acids (i.e., of approximately 200 Daltons) to high molecular weight proteins (of about 1 million Daltons, or more).

An especially promising class of disease markers in serum are the low molecular weight (LMW) PP fragments whose abundances and structures change in ways indicative of many, if not most, human diseases. The LMW serum proteome is made up of several classes of physiologically important polypeptides, such as cytokines, chemokines, peptide hormones, as well as proteolytic fragments of larger proteins. These proteolytically-derived peptides have been shown to correlate with pathological conditions such as cancer, diabetes and cardiovascular and infectious diseases. Analysis of the LMW serum proteome, however, requires extensive sample preparation and is notoriously difficult to analyze due to the large proportion of albumin (˜55%) that dominates the total amount of protein in blood serum. Other problems include he wide dynamic range in abundance of other LMW PP molecules, and the tremendous heterogeneity of the dominant glycoproteins. For example, the rarest proteins now measured clinically are present at concentrations more than 10 orders of magnitude lower than albumin. These rare proteins and peptides, however, may represent highly sensitive and selective disease markers and potential drug targets.

Traditionally, liquid chromatography (LC) or affinity-based methods are commonly used as a suitable separation process for serum components. Purification via LC methods involves chemically attaching linker molecules to a stationary phase (producing a functionalized stationary phase) in a LC column. Once the sample is loaded into the column, a mobile phase is flowed through the stationary phase. The fraction of the time each analyte spends bound to the stationary phase, rather than in the mobile phase, determines the relative migration rate of different analytes (as well as contaminants and interfering species) through the LC column, providing for purification of the analytes. For example, analyte molecules of interest, such as peptides and proteins, can be adsorbed onto a functionalized stationary phase while the contaminants are eluted from the column. Next, the mobile phase is adjusted so as to release the molecules of interest from the functionalized stationary phase. Often, a volatile buffer that is compatible with MALDI-MS, such as an acetonitrile/water mixture, is used as the mobile phase in this step. In this fashion, the purified molecules of interest are eluted from the LC column and collected for MALDI-MS analysis. The sample is now relatively free of salts and other contaminants that would otherwise interfere or otherwise limit the sensitivity of the analysis. However, these methods are time consuming and not amenable to high throughput methods.

There is a need therefore, for improved devices and procedures for separating, concentrating and adding reagents needed for analysis of samples during high throughput methods of analysis. Recent reviews of sample preparation techniques for mass spectrometry show that these methods remain time-consuming, cumbersome, require highly skilled labor and are difficult to automate. As a result, the number of samples that can be analyzed within any one clinical study is extremely limited, thus substantially hindering the level of statistical significance and, therefore, clinical relevance, of these studies. Consequently, due to the lack of high throughput sample preparation systems, the LMW serum proteome is largely unexplored, source of biomarkers (detectable by mass spectrometry) for disease, disease treatment and gene expression analysis in humans, as well as other animals.

Matrix-assisted laser desorption/ionization mass spectrometry (MS) analysis of samples deposited onto MALDI target plates is rapidly becoming a method of choice for analysis of proteins, peptides and other biological molecules. The MALDI-MS procedure is a very sensitive analytical method and is probably the MS procedure most compatible with biological salts and pH buffers. Further, its ability to generate high-mass ions at high efficiency from sub-picomole quantities of biological macromolecules makes this technique extremely useful for macromolecule analysis. Analysis of peptide analytes in crude biological samples, such as blood, plasma, or serum, however offers special problems for mass spectrometry analysis as described below.

The first problem to be overcome is that the biological samples contain high concentrations of salts (e.g. sodium, potassium, chloride, phosphate and carbonate). The anions especially suppress the ionization of peptide samples by the usual MALDI analysis procedures. The cations also are problematic in that they generate adduct spectra that split the primary mass peaks of proteins into a multitude of additional mass peaks each having the additional mass of one cation. Also, the success of MALDI-MS analysis depends to a great extent on the ability of the analyst technician to effectively crystallize a MALDI matrix substance mixed together with the analyte prior to injection into the mass spectrometer. The MALDI matrix substance is needed to absorb the laser light that provides for atomization and ionization of the matrix together with adsorbed analyte substances within samples to be analyzed. The ionized analyte molecules then are accelerated into a mass spectrometer ion detector by a high electrical field provided by high voltages on an anode and cathode within the mass spectrometer. When even relatively small amounts of contaminants (such as salts or glycerol) are present the ability of MALDI matrices to efficiently desorb and ionize analytes, such as proteins and peptides, is dramatically reduced. Furthermore, high salt concentrations increase both the threshold laser intensity required for MALDI-MS and the intensity of salt-adducted peptide peaks (at the expense of free peptide peaks).

Secondly, in samples, such as human serum, analyte peptides are frequently present at very low copy number compared to interfering proteins (e.g. albumin, immunoglobulins and transferin). The peptides of interest often are present at just 1 micromole per liter to 1 picomole per liter (e.g. 1 microgram to 1 picogram per ml). In contrast total albumin and gamma globulins such as IgG, IgM, are present at levels ranging from 0.01 to 0.1 grams per ml, i.e. up to 1×10¹¹-fold greater in mass. Thus, the major abundance proteins heavily dominate MALDI spectra of the mixture. Minor components are rarely observed because the low intensity peaks are obscured by the major peaks. This problem is made much more difficult in biological samples, such as human serum where such low copy number molecules need to be detected in the presence of many orders of magnitude higher molar concentrations of interfering proteins (e.g. albumin, immunoglobulins and transferin) and salts (e.g. sodium, potassium, chloride, phosphate and carbonate).

Thirdly, many of the analyte peptides are hydrophobic and are bound to the major proteins found in blood, plasma, or serum. Albumin especially tends to bind hydrophobic molecules nonspecifically. Thus, removal of the unwanted proteins such as albumin also results in the loss of analyte peptides. Chemically disruptive agents, such as salts and detergents are known to assist in the dissociation of analyte peptides from albumin. These agents actively suppress the MALDI process however. For example polyethylene glycol (PEG) and Trition ionize and desorb by MALDI as efficiently as peptides and proteins. As a result these species often compete with ionization of proteins and peptides and thereby suppress the MALDI-MS signals from the latter. Thus, after the addition of chemically disruptive agents to dissociate analyte peptides from albumin, the analyst must separate the analyte peptides from both the disruptive agent's albumin and other contaminating proteins. Additionally, the separation must be performed in such a way that the minor component peptide analytes are not lost during the separation process. This separation is made especially difficult when the analytes are hydrophobic and tend to adhere to hydrophobic surfaces. Unfortunately, purification of biopolymers by LC methods frequently results in 30%, or greater, sample losses and can add fcontaminants (or sample “cross-talk” to samples. For most MALDI-MS users, this amount of sample loss is unacceptable Fourth, because the analyte peptides are present at such low levels, they must be concentrated prior to MALDI-MS analysis. Carrying out first the dissociation of peptides, the separation of components, and then the concentration, by prior art methods is tedious and requires multiples steps that are both time-consuming and labor-intensive.

### SUMMARY OF THE INVENTION

One object of the present invention, therefore is to provide methods and devices to remove salts from biological samples.

A second object of the invention is to separate high abundance molecules, such as proteins, from biological samples thereby allowing reproducible and sensitive analysis of the remaining low abundance molecules.

A third object of the invention is dissociate analyte peptides from albumin and other hydrophobic proteins.

A fourth object of the invention is to concentrate analyte peptides and proteins of interest for MALDI mass spectrometry analysis.

A fifth object of the invention is to provide the first four objects of the invention in a convenient and effective manner, so as to achieve for high sample throughput.

A sixth object of the invention is to provide for handling a multiplicity of samples simultaneously, so that two-or more samples may be analyzed in parallel. Thus in combination with the other objects of the invention, an analyst will be able to utilize the instant invention to perform analysis of peptides and proteins in biological tissue samples in a convenient and efficient manner, thereby increasing the sensitivity of detection, increasing the sample throughput, as well as decreasing the cost of analysis. Lastly, there is a desire for analysis of the separated analyte peptides, polypeptides and proteins (analytes) to be done reproducibly and quantitatively. Thus a seventh object of the invention is to provide for reproducible and quantitative MALDI-MS analysis of peptides and proteins in biological samples.

Another aspect of this invention is a cartridge comprising: a cartridge well frame including a plurality of wells and at least one lower reservoir port; a cartridge gel plate including a plurality of holes; a cartridge capture slide including a plurality of holes; a spacer including a plurality of holes wherein each hole is at least partially filled with a porous material; and a cartridge buffer reservoir frame wherein a plurality of wells in the cartridge well frame is substantially aligned with a plurality of holes in each of the cartridge gel plate, the cartridge capture slide, and the spacer.

Yet another aspect of this invention is An instrument comprising: a housing; and a test chamber located in the housing, the test chamber further including: (i) an electrode array including a plurality of sample electrodes and at least one return electrode; (ii) a tray for holding a cartridge, the cartridge including a plurality of sample wells and at least one lower reservoir port, the electrode array moveable towards the cartridge such that at least a plurality of the sample electrodes are located in sample wells and the at least one return electrode is located in the at least one lower reservoir port; and a control system for controlling the application of a voltage and/or current to the plurality of sample electrodes and/or the at least one return electrode.

Employing the term PP to refer to oligopeptides ranging from small size of two, or more, amino acids to large proteins of 1 million Daltons, or more, an eighth object of the invention is to provide an analysis system to examine the LMW fraction of PP in human serum by mass spectrometry (MS). A ninth object of the invention is to provide a PP Analysis System (PPAS) with sufficient versatility that that a wider range of PP, for example from 500 Daltons to 500,000 Daltons, or more, also can be analyzed by mass spectrometry (MS). A tenth object of the invention is to provide improvements to the PPAS to further increase the sensitivity of detection so that quantities of PP from 1 nanomole to 0.1 attomole, or less, can be detected, quantified and molecular weight measured by MS. An eleventh object of the invention is to provide for increased fractionation and separation of PP in human serum so that low abundance PP can be separated from higher-abundance PP prior to MS analysis thus providing increased sensitivity of detection of the low abundance PP.

### DESCRIPTION OF THE FIGURES

FIG. 1 is a schematic cut-away drawing of a single well of an Analysis System. In a preferred embodiment of the Analysis System has a 8×12 array of 96 sample wells contained within a cartridge;

FIG. 2 shows the components of a cartridge embodiment;

FIG. 3A is a perspective view of an assembled cartridge of FIG. 2;

FIG. 3B is a side cut-away view of an assembled cartridge of FIG. 2;

FIG. 4 is an alternative cartridge embodiment;

FIG. 5 is a view of the top of a cartridge well frame component of the cartridge of FIG. 2;

FIG. 6 is a view of the bottom of a cartridge well frame of the cartridge of FIG. 2;

FIG. 7 shows a cartridge capture slide;

FIG. 8 shows a buffer reservoir frame component of the cartridge of FIG. 2;

FIG. 9 depicts a cartridge buffer reservoir frame including a space;

FIG. 10 is a side cut-away view of a portion of the assemble cartridge of FIG. 2 including an indication of the gel level;

FIG. 11 is a block diagram of a workstation instrument, CPU and user interface;

FIGS. 12A and 12B are views of a PPS instrument housing embodiment of this invention;

FIG. 13 shows a PPS instrument test chamber with the lid open and with no cartridge installed;

FIG. 14 shows a test chamber of the PPS instrument wherein the lid is shown transparent so the internals of the test chamber can be seen;

FIG. 15 shows the test chamber with the lid open looking up at the electrode array installed in the test chamber cover;

FIG. 16 side internal view of a PPS instrument of this invention;

FIG. 17 is an internal view of a PPS instrument of this invention including thermal electric coolers and heat sinks;

FIG. 18 is an embodiment of an analog circuit board microcontroller design embodiment useful in a PPS instrument;

FIG. 19 is an embodiment of an analog circuit channel design useful in the PPS instrument of this invention; and

FIG. 20 is a schematic of an instrumentation and control diagram for a PPS instrument embodiment of this invention.

### DESCRIPTION OF THE PREFERRED EMBODIMENTS

One aspect of this invention is a Peptide and Protein Analysis System (PPAS) that electrophoretically separates, concentrates and captures low abundance proteins and polypeptides present in serum (or from other tissues) onto a solid-phase capture slide. Following a brief rinse step, salts and other interfering molecules are washed away. Then, a MALDI matrix solution is applied to the capture slide. The matrix solution releases the proteins for incorporation into MALDI matrix crystals that precipitate on the slide surface upon drying. Next the slide is inserted directly into a MALDI-MS instrument for quantification of both the mass and the relative abundance of the captured proteins.

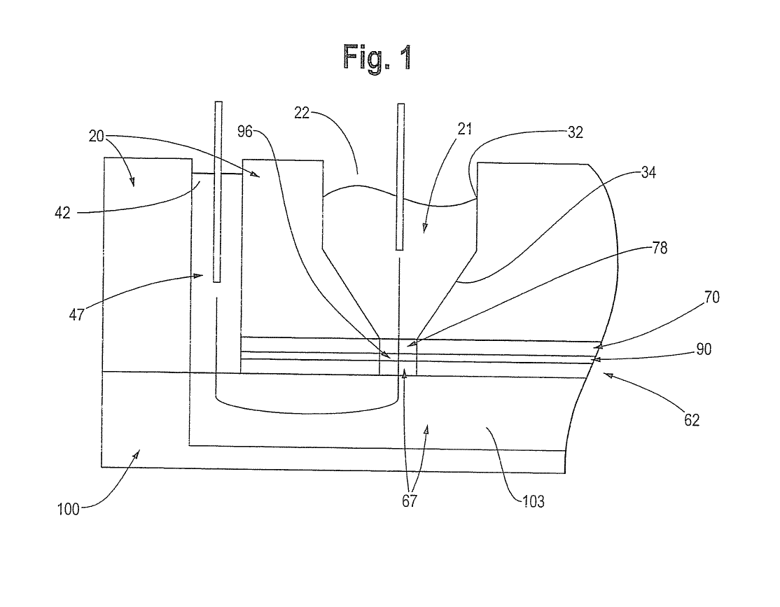

The PPAS of this invention is comprised of two primary components a cartridge capture slide (“cartridge”) and a workstation instrument. The cartridge is designed such that a plurality of independent electrophoretic circuits can be created when interfaced with the workstation instrument. A schematic of a single electrophoretic circuit is provided in FIG. 1.

In one embodiment, the cartridge is divided into four quadrants of 24 wells each. Each of the wells in a quadrant has a dedicated sample electrode. Therefore, there are 24 sample electrodes per quadrant and 96 sample electrodes per cartridge. Each of the quadrants has a single common electrode that communicates with each of the 24 sample electrodes. Therefore, there are 4 common electrodes for each cartridge.

During electrophoresis, proteins in the sample migrate through the gels and are captured in the cartridge capture slide. When electrophoresis is complete, the cartridge capture plate is disassembled and the cartridge capture slide is installed in a MALDI sled in preparation for mass spectrometry to analyze the proteins that were captured.

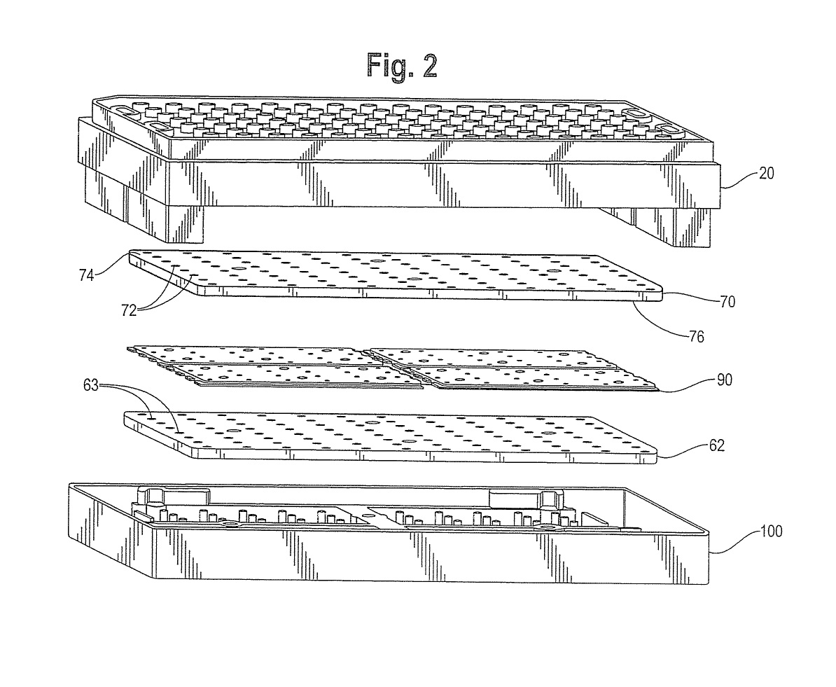

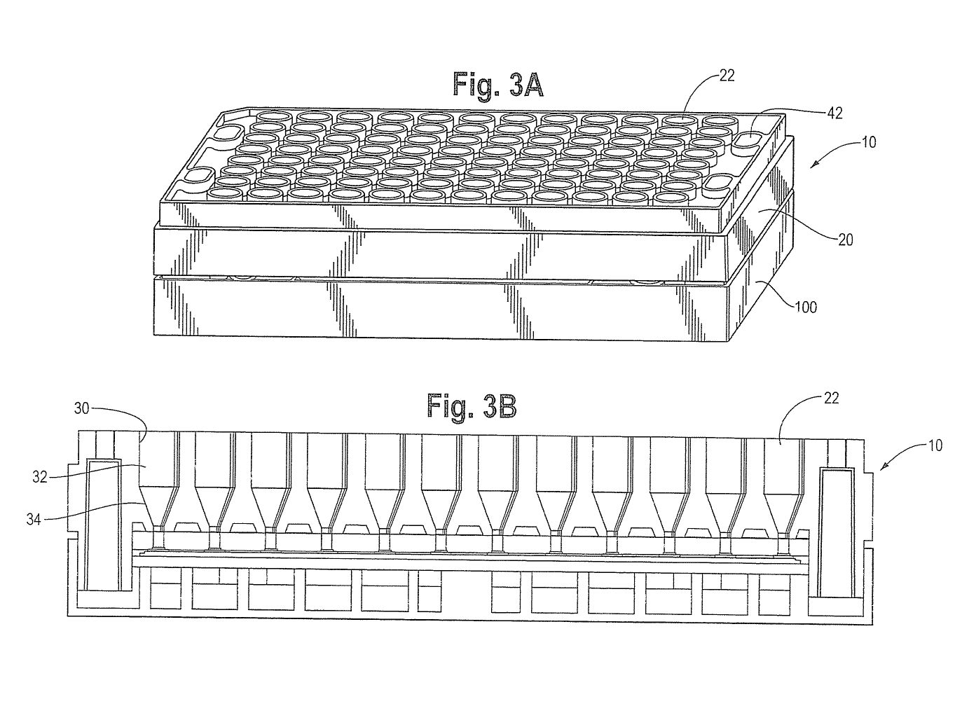

One embodiment of components of a cartridge (10) is shown in FIG. 2. An assembled cartridge (10) (with optional cover 12 removed) is provided in FIG. 3A. A section view is provided in FIG. 3B. Cartridge (10) comprises an optional cartridge cover (not shown); cartridge well frame (CWF, 20); spacer (62); cartridge gel plate (CGP, 70); cartridge capture slide (CCS, 90); cartridge buffer reservoir frame (CBRF, 100). The elements of the cartridge embodiment shown in FIG. 2 are assembled and stainless steel screws that pass thought holes (95) in the cartridge well frame (20) and holes (95′) in the cartridge buffer reservoir frame (100) are used to secure the elements of cartridge (10).

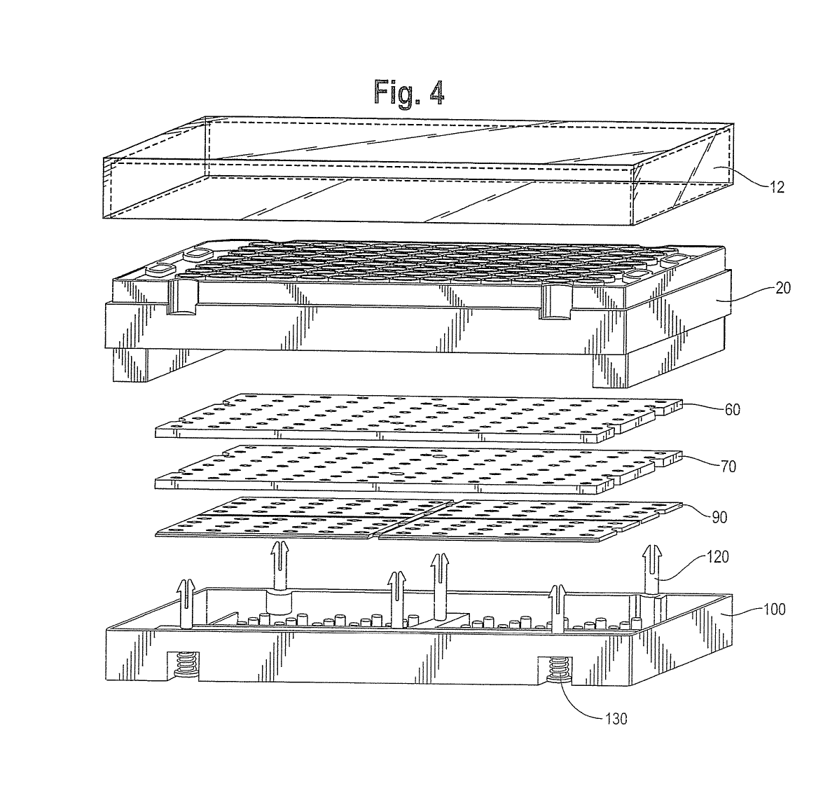

Another embodiment of a cartridge is shown in FIG. 4. In addition to the features indicated above, the alternative cartridge includes a gasket (60) and does not include a spacer. Moreover, in this alternative embodiment, the gasket (60) and the cartridge gel plate (70) are in a different orientation. Moreover, the alternative cartridge includes an optional push-in-fastener (PIF, 120); and optional spring (130). Each of the cartridge components is described in more detail below.

Cartridge Cover

The cartridge capture slide of this invention may include an optional cartridge cover (12). If used, cartridge cover (12) is preferably a clear material that can be placed over the Cartridge by a user for storage. A standard commercial-off-the-shelf cover for a 96-well microplate is preferably used for this component.

Cartridge Well Frame (CWF)

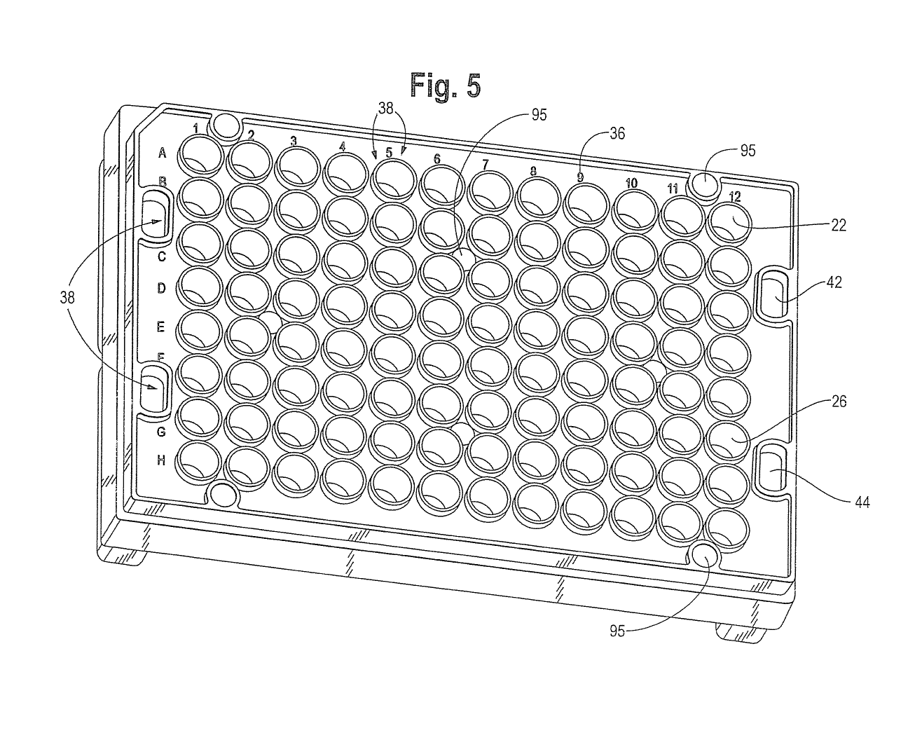

The cartridge well frame (20) includes a plurality of sample wells (22) and is designed to have a footprint and well-to-well pitch that is identical to a multi-well microplate. Preferably the CWF comprises 96 wells. While other configurations using more or fewer wells may be utilized, the use of 96 wells allows users to use existing, commercially-available liquid handling robots to fill sample wells (22). In addition to the 96 wells in a preferred embodiment, there are 4 lower reservoir ports (42; see FIG. 4 and 5). Lower reservoir ports (42), which are filled with an electrolytic buffer solution, are each designed to accept common electrodes (also referred to herein as return electrodes or common counter electrodes) which are also described below.

As shown in FIG. 5 for the preferred embodiment, each well comprises a top opening (26) and a bottom opening that is also a sample hole (28) and side walls (30) that comprise a cylindrical section (32) and conical section (34). This design minimizes the height of the CWF while ensuring a smooth transition from the top diameter of about 6.86 mm to the bottom diameter of about 1.8 mm. The well volume is about 360 μL. Preferably, each well is labelled with an identifier (36).

The CWF also comprises one or more lower reservoir ports (42). In the embodiment shown in the figures, the CWF includes four reservoir ports. Each reservoir port (42) has a top opening access hole (44), a bottom opening (46), and side walls (48). The reservoir port (42) is preferably rectangular in cross section.

As shown in FIG. 5, each of the 96 wells and the 4 lower reservoir ports (42) include a rim (38) of about 2 mm height. Rims (38) ensure that any minor spills that occur during preparation of and assembly cartridge (10) and any bubbling that may occur during operation will not contaminate any adjacent wells.

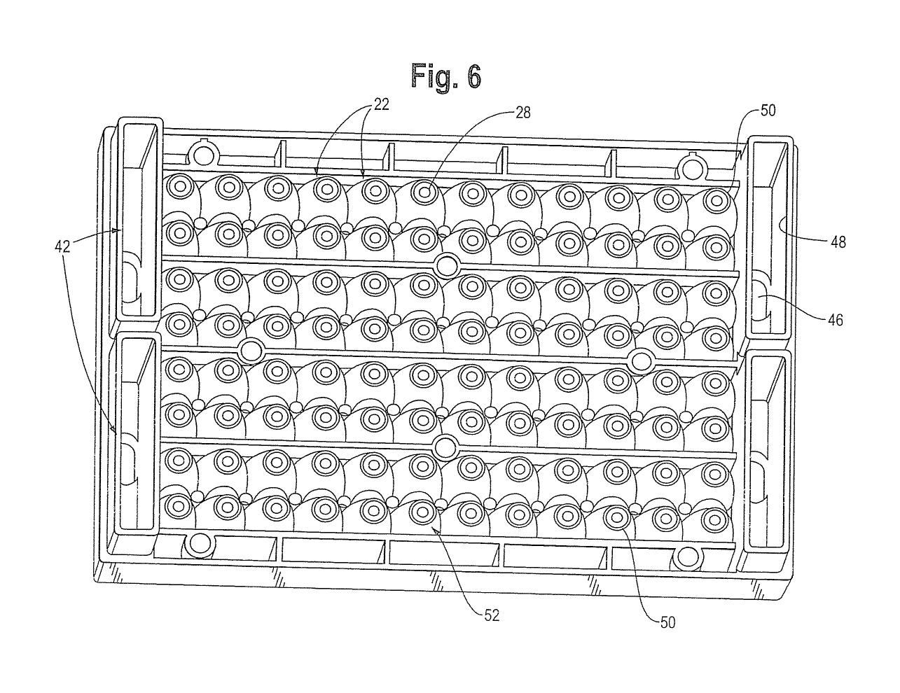

The opening (44) for each of the lower reservoir ports is about 5 to 7 mm and preferably 6.5 mm in diameter. This diameter is sufficiently large to allow any bubbles that are generated during electrophoresis to vent to the atmosphere without “spattering”. As shown in FIG. 6, the main volume of ports (42) is preferably rectangular in cross section. However other cross-sectional shapes may be useful. A rectangular cross-section, however, maximizes the volume of the port, which, in turn, maximizes the amount of buffer in each cartridge quadrant. This helps to minimize buffer heating and ensures that sufficient buffer is available to account for losses due to electrolysis of the buffer at the return electrode. The division between the four quadrants in the cartridge is shown in FIG. 6 with a dashed line (52).

As shown in FIG. 6, an optional raised lip sealing feature (50) may be included around bottom opening (28) of each sample well (22) in cartridge well frame (10). Raised lip sealing feature (50) facilitates the concentration of a load around opening (28) of samples wells (22) and against cartridge gel plate (70) of FIG. 2 or gasket (60) of FIG. 4 to create a well seal.

The CWF can be made of a variety of materials that are preferably non-conductive. Useful materials are non-conductive rigid polymers, such as polypropylene. One especially useful material is non-conductive glass fiber filled polypropylene.

Cartridge Gel Plate (CGP)

The CGP (70) has an upper surface (74) and a lower surface (76) and a plurality of holes (72). Preferably, CGP (70) has 96 holes (72) that substantially align with cartridge well frame well bottom opening (28). Each hole (72) is filled with an analyte separation layer (78). A preferred analyte separation layer (78) is polyacrylamide gel. For example, a 6-12% (preferably about 8%) polyacrylamide gel and is preferably about 1.8 mm in diameter to match up with the holes in the CWF and CCS. The CGP is preferably about 2.38 mm thick.

In a particularly preferred embodiment, the lower surface of the CGP includes sealing elements circumscribing each CCS hole and bottom sealing element. The sealing element may be, for example, an O-ring, or a rib, ridge or other raised moulded feature of the CGP.

The CGP may be made of polypropylene, polyethylene, or silicone rubber of suitable hardness to provide for sealing. In one embodiment, the CGP is made from an injection moldable elastomer material (trade name of Santroprene). This material is a mix of polypropylene and rubber materials. The CGP material hardness (durometer hardness Shore A of about 60) was selected to provide adequate sealing of the cartridge capture slide and also provide adequate dimensional stability to the CGP.

Cartridge Capture Slide (CCS)

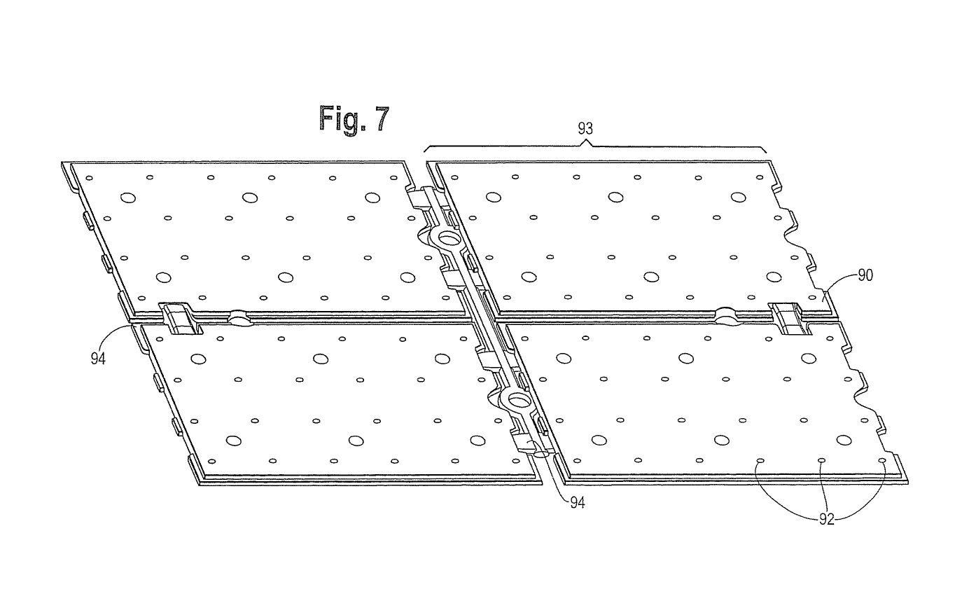

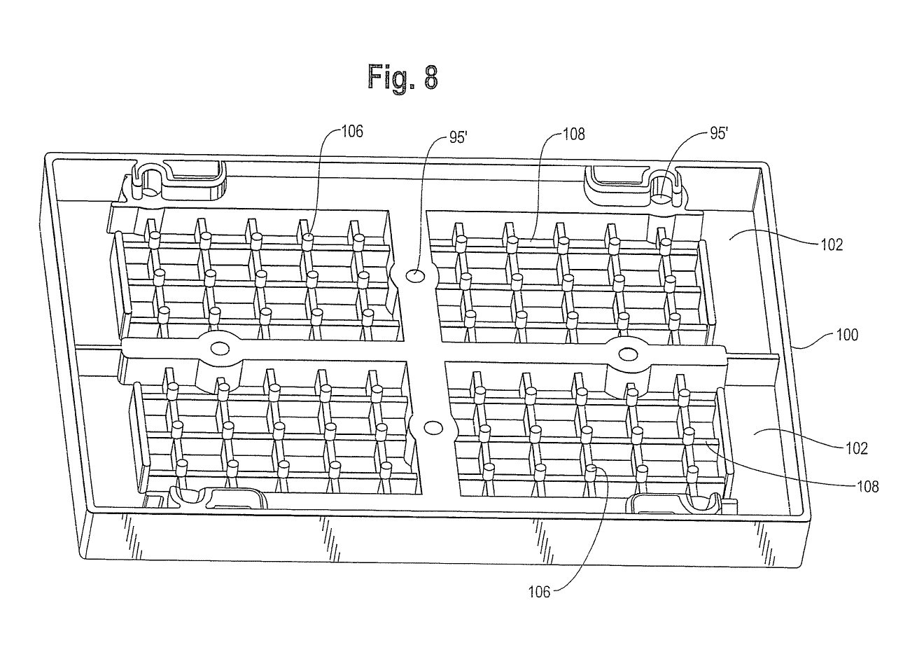

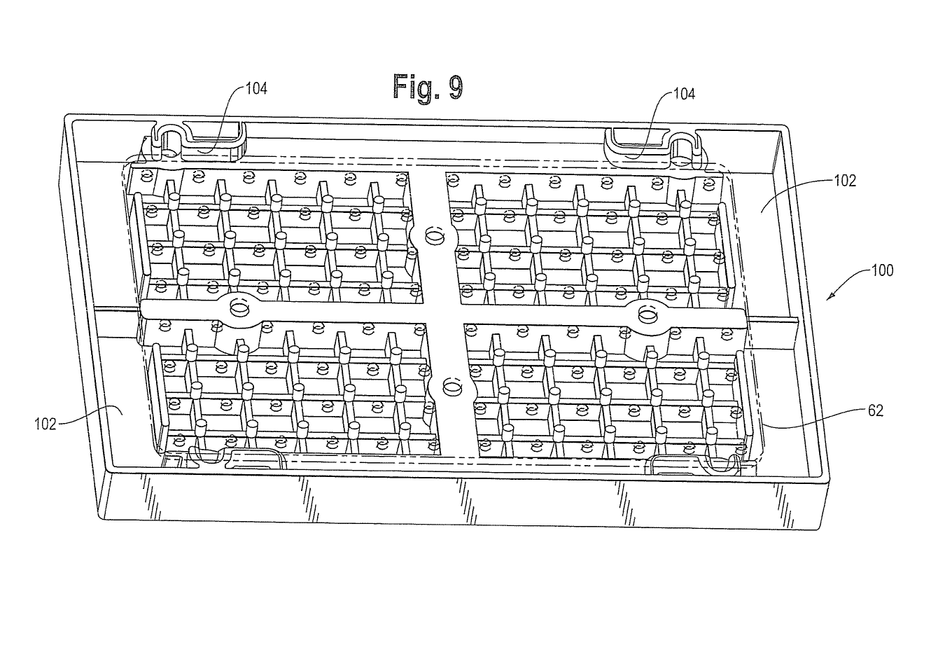

The cartridge includes a cartridge capture slide (CCS) (90) comprising a plurality of holes (92) that are coaxial and align with holes of the CWF, CGP and spacer. In the preferred embodiment, the CCS contains 96 capture slide holes (92) and preferably comprises of four quadrants (93) (each containing 24 capture slide holes) connected by breakable tabs (94) (see FIG. 7). The quadrants allow a user to optionally reduce the size of the CCS to facilitate insertion into a mass spectrometer. The four quadrants are injection moulded as a single part. Following completion of electrophoresis, the user snaps the quadrants apart before installing them in the MALDI sled.

In one embodiment, each CCS has 96 holes that align with the holes in the CWF, CGP and spacer. Each of the CCS holes is filled with any porous material that is able to capture proteins during electrophoresis. The CCS holes are preferably smaller than the holes of the CGP. This ensures that the gel layer on the CGP completely covers the holes in the CCSs even when the two layers are not perfectly aligned, and facilitates concentration of the analytes into a very small sample area for analysis by MALDI mass spectrometry. Preferably, the holes of the CCS are about 1 mm in diameter or smaller.

Various materials may be used to make the CCS. Preferably, the material that is selected meets the following requirements: (1) Flatness—The CCS should be flat enough to ensure that accurate results can be achieved during mass spectrometry. Generally the surface should be flat to within plus or minus 25 microns; and (2) Conductivity—In order to get accurate results from mass spectrometry, each sample site should be electrically connected to the mass spectrometer sled into which the CCSs are installed. The method used to provide this conductive path should also limit leakage current between sample sites and not cause the formation of bubbles that can disturb the electrophoresis process. The volume resistivity of the material is preferably from about 5×10⁶ to about 5×10⁸ ohm centimeter, more preferably about 5.5×10⁷ ohm centimeter.

A optional CCS material is polypropylene homopolymer based Permastat 107 Black, available from RTP Company, Winona, Minn. Alternatively, a PEEK plastic that is doped with conductive particles or fiber may also be used (e.g., Carbon Fiber Filled Polyethertherktone (Polyetheretherketone CAS# 29658-26-2; Carbon Fiber CAS# 007782-42-5; PTFE Lubricant CAS# 009002-84-0, available from TP Composites, Inc., Aston, Pa.). Other materials that substantially meet the above guidelines may also be used.

Each CCS hole (92) may include a capture material (96) for capturing molecules such a proteins of interest. Examples of useful capture materials include, but are not limited to hydrophobic porous polymethacrylate, such as poly(butylmethacrylate), poly(methylmethacrylate) poly(ethylene-dimethacrylate) poly(benzylmethacrylate, or mixtures of these polymers, such as poly(butylmethacrylate-co-ethylene-dimethacrylate). Alternatively, the capture material may be a hydrophilic porous polymethacrylate, such as poly(2-hydroxyethylmethacrylate), poly(glycidylmethacrylate), poly(diethylene glycol dimethacrylate), or mixtures, thereof. Still more advantageously the capture material may be formed from a mixture of hydrophilic and hydrophobic polymers, such that the hydrophobicity may be precisely selected from a range of hydrophobicities

Spacer

The cartridge of FIG. 2 includes a spacer (62). Spacer (62) is located between cartridge capture slide (90) and cartridge buffer reservoir frame (100). Each spacer (62) has 96 holes (63) that substantially align with the holes in the CGP and CCS. Each hole is filled with a conductive electrolyte (67). Preferably the conductive electrolyte (67) is a gel such as agarose gel and each hole (63) is preferably 3 mm in diameter—essentially the same diameter as the holes in cartridge capture slide (90) and smaller that the bottom opening (28) in cartridge well frame (20). Spacer (62) will have a thickness sufficient to allow the spacer to be made of a standard polymer such as from a standard polypropylene sheet or that allows spacer (62) to be manufactured by injection moulding. In one embodiment, spacer (62) is 1.59 mm ( 1/16 inches) thick.

Cartridge Buffer Reservoir Frame (CBRF)

In one embodiment, the CBRF (100) contains four independent reservoirs (102) that are filled with an agarose gel (103) to electrically connect the holes in the bottom of the CCS to the electrolytic buffer solution in lower reservoir ports (42).

As shown in Figure, CCS (90) and spacer (26) are preferably supported on their perimeters by ridges (104) on the CBRF (100). Additionally, post features (106) are raised from the bottom of the CBRF to provide support between holes. These supports are used to prevent bowing of the CCS that could prevent the sealing elements in the CCS from generating a sufficient seal.

Rib features (108) that connect the post features are also included in the design to stiffen the CBRF. These features only raise a portion of the way from the bottom of the CBRF. This allows the feature to add stiffness without restricting the flow of electrons in the agarose gel. Four internal fastener holes (95) are included in the CBFR design. These holes and the assembly fasteners, provide alignment for CCS, CGP, and spacer. The CBFR also includes levelling features (110).

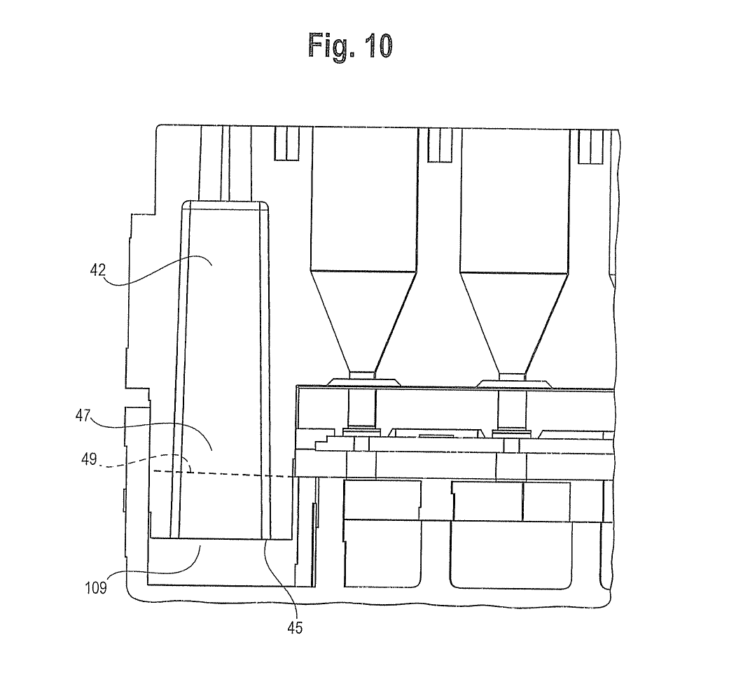

A cavity (109), shown in FIG. 10, is designed into the sides of the CBRF to accept lower reservoir port. As shown in FIG. 10, lower reservoir port (42) extends below the agarose gel level (49). During assembly, lip (45) on the bottom of the lower reservoir port (42) is pressed into the agarose gel to form a seal between the electrolytic buffer solution (47) in lower reservoir port (42) and the preferred agarose gel in the CBRF.

Assembly

Cartridge (10) is assembled using 8 stainless steel socket head cap screws (4-40, 0.75″ long). Stainless steel nuts are press fit into the bottom of the CBRF. The cap screws are inserted from the top of the CWF and assemble to the pressed-in nuts.

The gasket, push-in fastener and spring that are described below are all features of the alternative cartridge capture slide shown in FIG. 4. In the cartridge capture slide of FIG. 4, gasket (60) is located between cartridge wall frame (20) and cartridge gel plate (70).

Gasket

Gasket (60) has holes (63) that align with the sample holes (28) in CWF (20). Gasket (60) is preferably about 1-2 mm thick, more preferably about 2 mm thick, which provides for sufficient stiffness while minimizing the depth of the gel layer.

Gasket (60) is preferably made of a material that is flexible, non-porous, uncontaminated with proteins and that is electrically insulating. Preferred materials are elastomers or any suitable viscoelastic polymer. Examples of suitable gasket materials include, but are not limited to, silicone, sorbothane, polyurethane, latex rubbers, neoprene. Particularly preferred is silicone elastomer. The gasket material is preferably selected to serve the following functions: (1) when the gasket is compressed it deforms and generates a seal around the sealing lips on the bottom of the CWF; and (2) when the cartridge is assembled, it is advantageous to generate uniform loads across all of the independent sample channels. The gasket is made of a material that is soft compared to the other materials in the cartridge, so it acts as a spring in the system. This spring distributes loads and results in a more uniform compression on the CGP and CCS.

Push-in-Fastener (PIF)

The cartridge optionally includes fasteners or other similar objects for connecting the CWF to the CBRF. Preferred are push-in-fasteners (PIFs) (see Figure) which provide a cost effective means of connecting the CWF to the CBRF (the PIF is a commercial-off-the-shelf product) and easy to disassemble. A tool to allow a user to dis-engage the PIFs in a single step is preferably provided with each instrument.

Optional Spring

The total stack-up height of the Gasket, CGP and CCS will vary (within their tolerances) from assembly to assembly. The fastener for fastening the CWF to the CBRF should be able to account for this variation without drastically changing the amount of compression on the Gasket, CGP and CCS. The addition of an optional spring in-line (130) with the PIF provides this flexibility. The spring preferably has a stiffness of about 55.98 lb/in and is designed to provide a force of about 3 lbs at each fastener (18 lbs total).

It should be noted that the foregoing describes a preferred cartridge assembly that includes 96 wells. However, the invention is not limited to 96 well systems and in fact encompasses other systems including any number of wells, for example those including 384 wells.

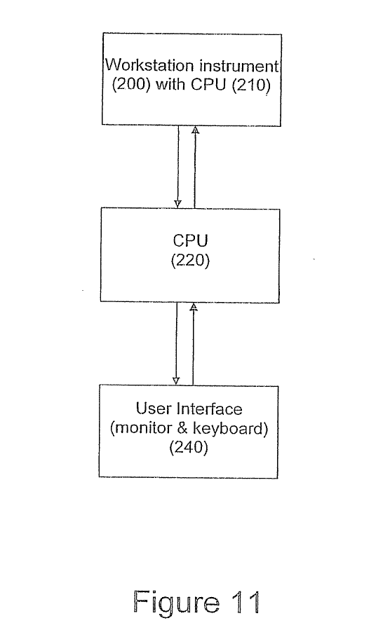

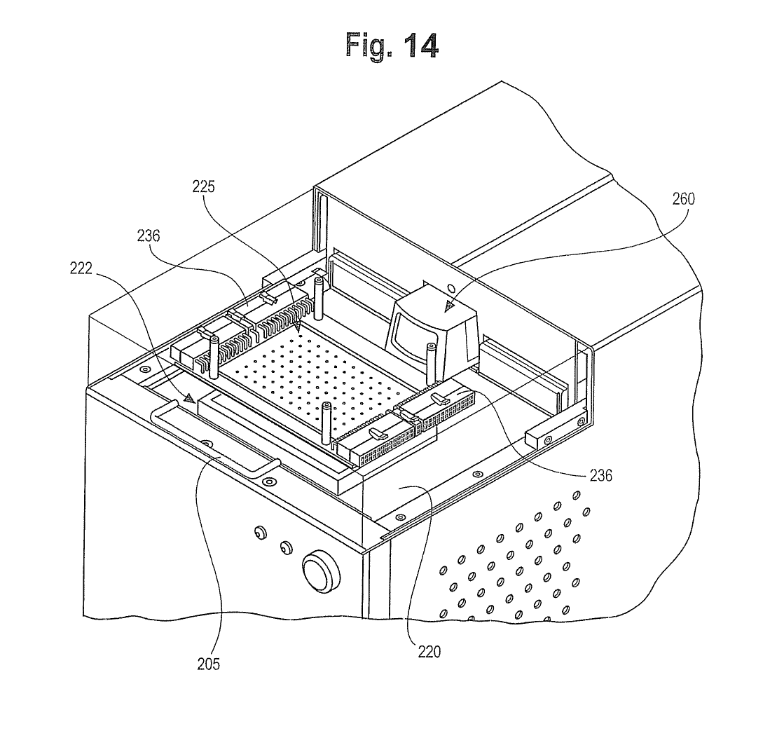

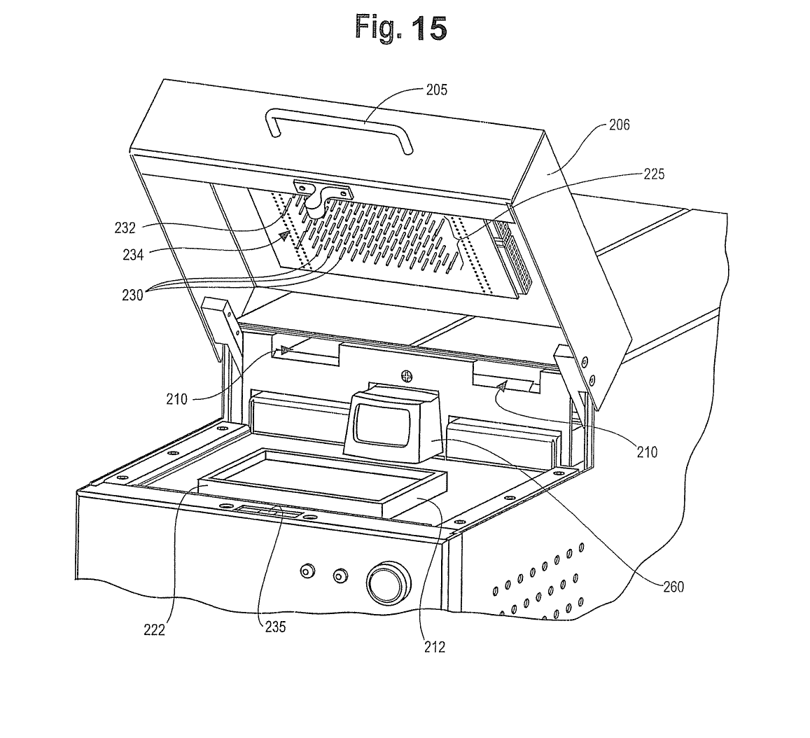

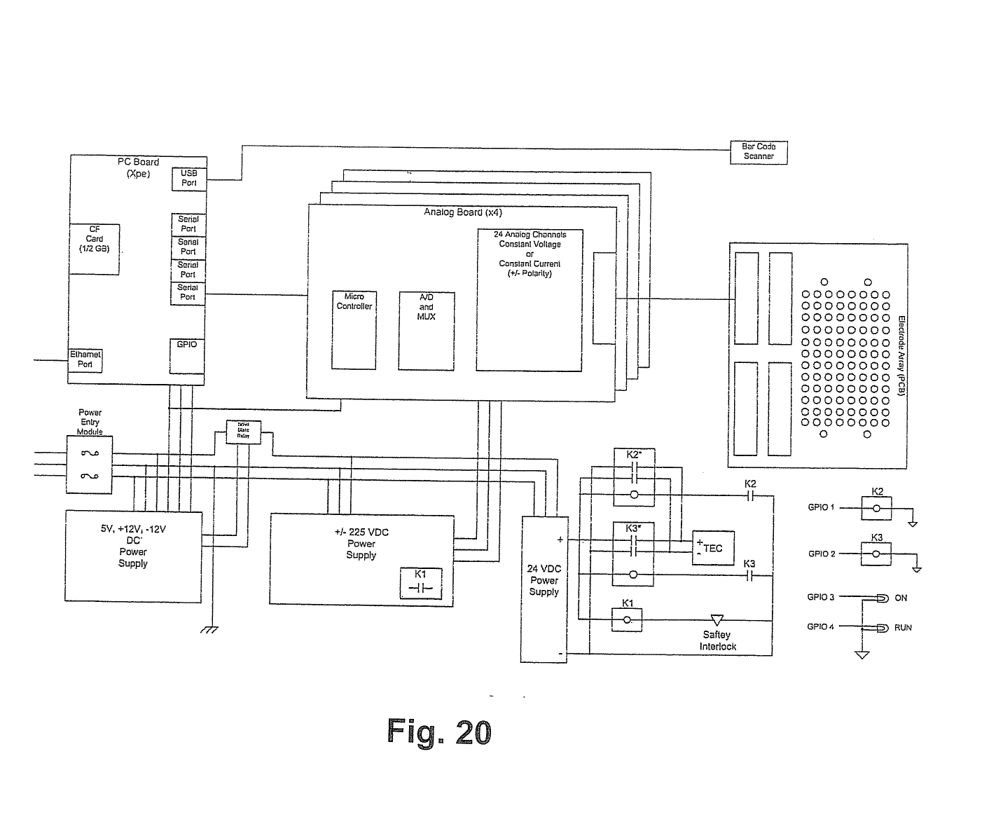

In operation, one or more wells (22) of the cartridge described above are filled with liquid samples (21) and then the cartridge is inserted into a workstation referred to herein as a Protein Profiler System Instrument or PPS instrument. The PPS instrument includes the sample and common electrodes required for electrophoresis. Various aspects of the PPS are shown in FIGS. 11-20. Referring to FIG. 11, PPS instrument 200 accepts cartridge assembly (10) and also contains a first central processing unit (CPU) (210). FIG. 20 is a more detailed schematic of the electrical and instrument control system of a PPS instrument embodiment of this invention.

The workstation instrument is controlled by firmware in the first CPU which, in turn is connected to an external computer (220) having a second CPU as well as a user interface (240) comprising a keyboard and monitor for control and feedback to the workstation operator. The second CPU in the external computer (220) also includes conventional software to facilitate entering instructions and for monitoring the operation of the workstation.

The PPS instrument (200) provides an enclosure which contains the components necessary to accomplish one or more of the following purposes: (i) house cartridges that contain protein samples; (ii) Control the current transmitted through or the voltage applied across each sample in the cartridge (via electrodes); (iii) Regulate power supply to electrodes and to instrument internal components; (iv) Provide feedback for data storage and feedback control of the voltage or current; (v) Properly configure electrodes into each of the 96 wells; (vi) Identify cartridges via bar code reader; (vii) Provide alerts and responses for system faults and errors (e.g., an alert when the lid is not properly closed); (viii) Measure and sample data for a plurality of sample wells (e.g. 96) at a sufficient rate and run total time; (ix) Comply with applicable safety regulations; (x); Provide a power supply capable of interfacing with US, European and Japanese wall outlets; and (xi) Allow the system to be controlled and driven by a Microsoft Windows-based network PC with a graphical user interface (GUI) designed to operate the PPS instrument.

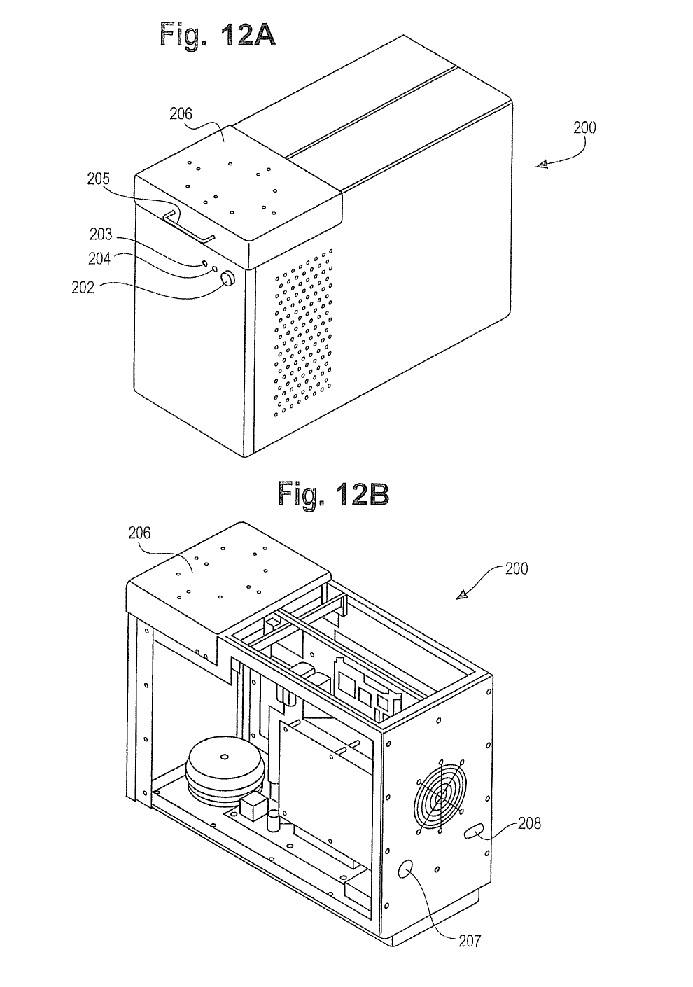

A PPS instrument housing (250) is shown generally in FIGS. 12A and 12B. The instrument housing shown in FIGS. 12A and 12B is approximately 20 inches tall, 11 inches wide, and 26 inches deep. The dimensions of instrument housing (250) are not critical and the dimensions may be varied, for example the instrument may be shorter and squatter if it intended to be used on a lab bench. The instrument front panel includes an ON/OFF push button (202), two LED indicators (203, 204), and a handle (205) for opening the cover (206) to the test chamber. A back panel includes two ports: an electrical power connector (207) and an Ethernet port (208). During use, the power connector is plugged into a standard electrical wall outlet. The Ethernet port is connected to a personal computer (PC) using, for example, a Windows operating system. The PC runs a graphical user interface (GUI) program to configure, run, and monitor the instrument.

PPS instrument (200) is used to apply a charge to each well of a multi-well cartridge to electrophoritcally drive proteins and other components of samples in each well through gels in the cartridge where they are captured in a cartridge capture slide. After processing, the multi-well cartridge is removed from the PPS instrument, it is disassembled to liberate the cartridge capture slide and the cartridge capture slide is installed in a MALDI sled for mass spectrometry to analyze the captured proteins and other biological material.

The PPS instrument is divided in to major sections (electrical, mechanical, and software). A single board computer (SBC) serves as a host computer for the instrument. On operating system such as Windows XP Embedded Operating System (XPe OS) is used to run the SBC. The SBC interfaces with a serial port interface. The SBC receives test profile information from a PC via an Ethernet interface. Analog circuit boards provide a controlled voltage or current to each sample through an electrode array. The system operates in one of two modes, controlled voltage or controlled current. The electrode array consists of a printed circuit board (PCB) (234) with a plurality of sample electrodes (230) and at least one return electrodes (232).

The SBC provides supervisory control for the four analog circuit boards, monitoring the operation and detecting fault conditions. Each analog circuit board uses a microcontroller to set, measure, and regulate the 24 channels on the board. This design provides flexibility and minimizes firmware development costs.

Each analog circuit PCB connects to the electrode array PCB through a wire harness assembly. This design allows for easy electrode array replacement should it become worn or damaged though normal use.

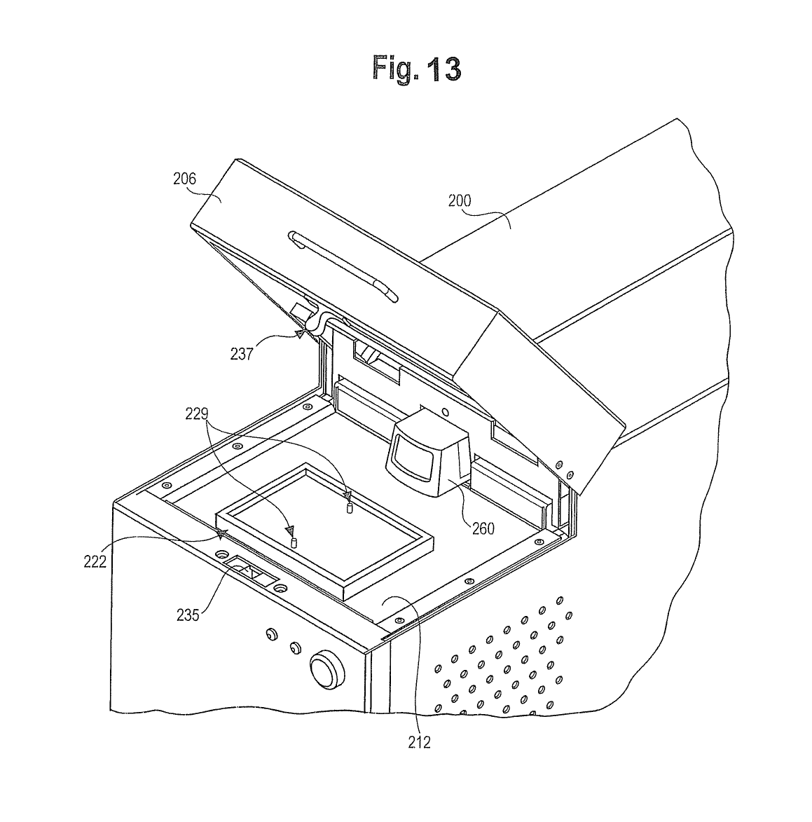

FIGS. 13-15 depict features of the PPS instrument test chamber (220) that is used for performing electrophoresis procedures on each well of a multi-well cartridge. The test chamber holds a cartridge and an electrode array (225). The bottom of the chamber is a tray (227) and nest fixture (222). A cover (206) encloses the top of the chamber and a hinge (210) along the back of the lid allows the lid to pivot open.

The multi-well cartridge is supported in the PPS instrument using a nest fixture (222). Nest fixture (222) accurately and reproducibly locates a multi-well cartridge and serves as a heat sink for the heat generated within the multi-well cartridge during operation. The multi-well cartridge used in the PPS instrument should have at least two wells. Preferably the multi-well cartridge in the 96-well cartridge discussed above.

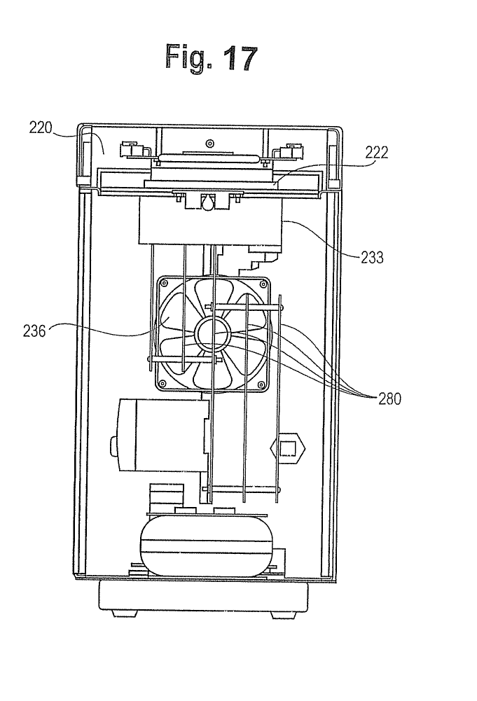

One or more thermal electric coolers (233) (TEC) and/or heat sinks (shown in FIG. 17) may be used to regulate the temperature of nest fixture (222) as needed. Other electronic components found in the test chamber include an optional bar code scanner (230) to record cartridge label information and a safety interlock switch (235) associated with latch (237) that detects door position and is used in conjunction with a relay (not shown) to secure the high voltage power supply whenever the door is open to the test chamber. It is preferred that two thermal electric coolers (TECs) are mounted to the bottom of the cartridge “nest”, as shown in FIG. 17, to regulate the temperature of the instrument process chamber. One useful thermal electric cooler is a Melcor thermal electric cooler (TEC) CP 1.0-254-06L. Each TEC is regulated by a relay driven by a general purpose I/O pin on the SBC. The SBC software monitors and regulates the temperature. Moreover a heat sink and fans (236) may be used with the TECs to exchange heat to the ambient atmosphere.

The optional safety interlock switch has two mating halves mounted to cover (206) and tray (212) of the chamber. The safety interlock interrupts power to the electrode array whenever the cover (206) is open. The electrode array is mounted to the hinged cover (206) of test chamber (220). Opening cover (206) allows the multi-well cartridge to be inserted and removed from nest fixture (222). The hinged cover is designed so that when the cover is opened and closed, the electrodes clear the openings in the cartridge. The bottom tray (212) chamber (220) is spill proof and a gasket is placed between the nest and the tray to form a seal between the test chamber and the instrument electronics. The multi-well cartridge nest further includes two alignment pins (229) that are used to ensure the multi-well cartridge is inserted correctly in the nest and in alignment with electrode array (225).

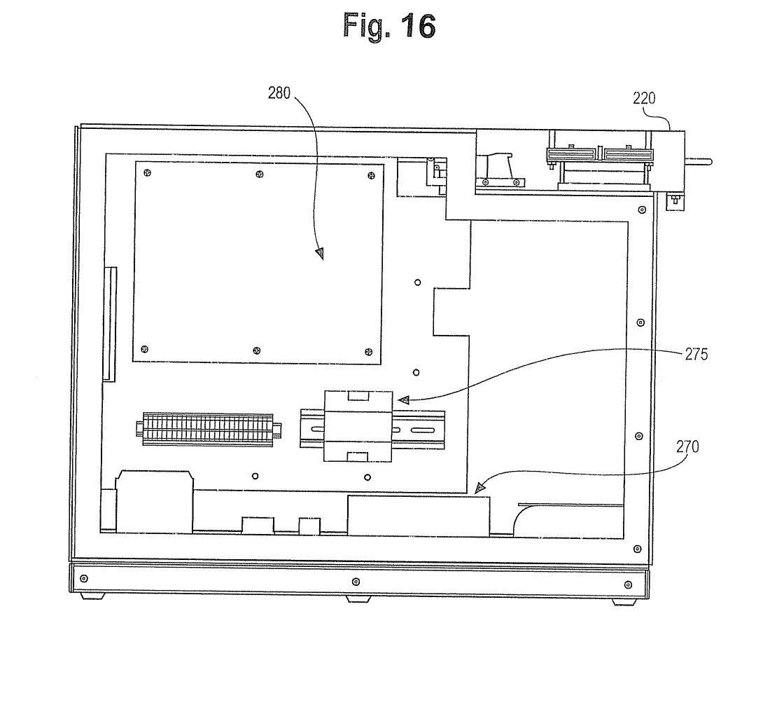

Three power supplies are included in the PPS instrument. A low voltage supply (270) is provided to supply 5, +12, and −12 V DC to the computer components within the instrument. A 24 V DC supply (275) is used to power the TEC and relays used in the instrument. A +/−225 VDC supply is isolated from the rest of the system and is used to drive the sample channel power electronics. The low voltage supply is compatible with the ATX standard and works with the Single Board Computer (SBC). A push button (202) on the front of the instrument case is used to energize the ATX supply. A solid state relay is used to supply line power to the 225 V and 24 V supplies. The solid state relay coil is connected to +12 V on the ATX supply and the solid state contact is connected to L1 (input power hot). Upon shutdown, the user presses the push button on the front of the instrument case, a signal from the ATX power supply instructs the XPe OS to shutdown, and after shutdown of the OS the ATX supply goes to the off state. Finally, the 225 V and 24 V supplies are de-energized when the solid state relay contact opens on loss of ATX supply (+12V) power. The locations of the electrical system components within the instrument enclosure are shown in FIG. 16.

An electrode array PCB connects the electrical system of the instrument to the samples under test. The electrode array (225) has at least two sample source electrodes (230) and at least one return electrode (232). The number of source electrodes (230) may vary depending upon the number of wells in the multi-well cassette. When the preferred 96 well cassette is used, the PPS instrument will include 96 source electrodes (230) and 4 return electrodes (232).

The electrodes (230) and (232) may be made out of any conductive material. In one example, the electrodes are platinum coated stainless steel. In another embodiment, the electrodes are solid platinum. In still another embodiment the electrodes are platinum coated over an inert material such as a polymer. In one preferred embodiment, the electrodes are nylon pins that are sputter coated with platinum. Electrodes (230) and (232) and are pressed and soldered into a circuit board. The electrode array PCB (234) is mounted in the unit using fasteners and an electrical connector (236) is used to connect the electrodes to the analog circuit PCB. In one embodiment, a total of eight connectors are used. Four 24-pin connectors are used for providing the interface from the supply voltage (i.e., +/−225 VDC) electrodes to each of the analog circuit PCBs. Four 2-pin connectors are used for providing the interface from the return electrodes (i.e., DC common) to each of the analog circuit PCBs. The electrode array PCB assembly (234) is designed for occasional removal in the event the electrode array should become worn or damaged.

Analog circuit PCBs (280) are used to control the amount of current that is supplied to each of the source electrodes (230). An Atmel ATMega128 series microcontroller is used to manage each major area of operation of the analog board, and reports actual performance to the single board computer (SBC) via the host interface. The microcontroller monitors the outputs for compliance with the set point, adjusting the voltage/current if necessarily to insure that it is within the tolerance of the system. At intervals up to 2 Hz, the analog board generates an update to the single board computer with the present voltage/current readings on each output channel. Each channel of the analog circuit is controlled by the microcontroller using a low-level (i.e. up to +/−5VDC) analog control voltage through a Digital-to-Analog Converter (DAC). This voltage level is latched in a Sample & Hold (S/H) analog output register. (There is one analog S/H channel output per output pin, or 24 per board.) Each analog output is then signal-conditioned and voltage level-shifted to drive either the positive or negative pass-transistor for output to that channel. The microcontroller monitors and makes adjustments as often as necessary to maintain the output voltage/current at the set point for the duration of the sequence step. Each analog output on the S/H is refreshed more than 4 times per second to prevent any droop or decay on the outputs of the S/H. Variances or changes in the output voltage due to load adjustments are made quickly as a result of this continuous adjustment process.

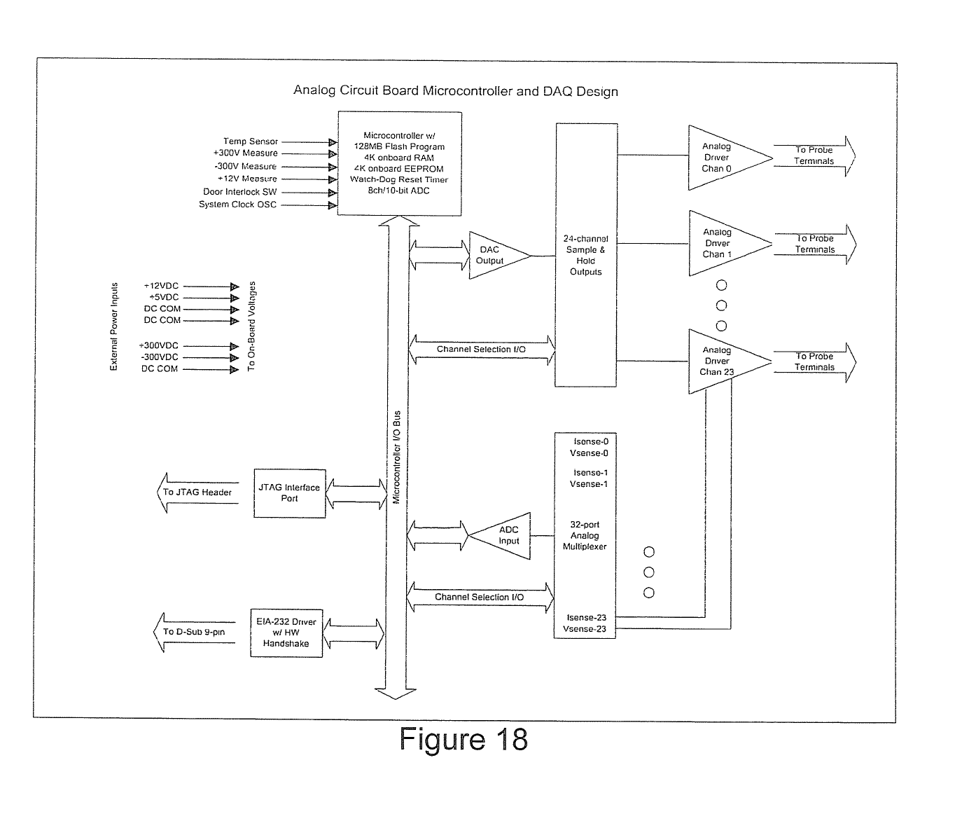

The microcontroller monitors the outputs through two analog inputs per channel via an analog multiplexer. The analog multiplexer allows the microcontroller to select which of the analog readings to convert on the ADC, and reduces the ADC channel-count requirement. Since the ADC can only convert low-voltages, these monitored signals are scaled down to a valid range via a 0.1% tolerance resistor network. The combined network of these resistors exceeds 1MΩ open-circuit. A “Vsense” voltage shown in FIG. 18 measures the precise voltage supplied to that channel. The “Vsense” voltage read for each channel is converted to a digital value for transmission to the single board computer. Reading the differential voltage across the sense resistor (“Rsense” shown in FIG. 18 is translated directly into a current to a channel. This differential conversion is calculated into a current for each channel, and transmitted to the single board computer.

The microcontroller design includes an optional temperature probe. This temperature probe is used to provide feedback on the operating temperature. This reading is reported to the single board computer. Other inputs monitor the positive and negative 225 VDC supplies, as well as the low-voltage supplies used on the analog board. Each of these is monitored for compliance with established tolerances.

A single board computer (SBC) plays a supervisory role for analog circuit boards in an instrument. In a preferred embodiment, the PPS instrument will have four analog circuit boards. The SBC receives a test profile from the end-user PC. The single board computer then enables the analog boards, loads set points and controls the timeline. The single board computer updates the next sequence prior to the expiration of the current step and initiates the new step with a “GO” command. If the single board computer fails to update the next step, the prior step will timeout and the output voltage returns to a safe mode. The single board computer also monitors the process via the measured current and voltage to check for any fault conditions that may occur. The analog board regulates each output to the set point received from the single board computer. The SBC interface is made with an EIA-232 serial connection, and also support hardware handshaking lines (CTS/RTS). This connection is a standard D-sub 9-pin (similar to PC format).

Each analog board generates 24 analog outputs, and provides for 1 common return point. Each analog output is controlled and set independently, and regulated continuously. A set of 225 VDC power supplies will provide positive (+) and negative (−) DC power to each analog board. There is one set of bulk supplies per instrument (4 analog boards per power supply-set.)

Voltage Regulation Mode

In Voltage regulation mode, the microcontroller receives a set point from the single board computer defining the voltage level target to an output electrode. This output voltage is generated and maintained at the target voltage level independent of the load's current-draw. The output power per electrode is limited to 100 mW. The actual output voltage may be automatically reduced to stay within the 100 mW maximum power per output channel.

Current Regulation Mode

In Current regulation mode, the microcontroller receives a current set point from the single board computer defining the current level target to the output electrode. In this case, the current is monitored, and the output voltage is adjusted to achieve the desired current to each electrode. Again, since each output electrode's power is limited to 100 mW, the actual output current may be automatically reduced to stay within the 100 mW maximum power per output channel. In both modes of operation, current and voltage is monitored and reported to the single board computer. The mode only determines which sensing measurement is used to regulate the electrode's output.

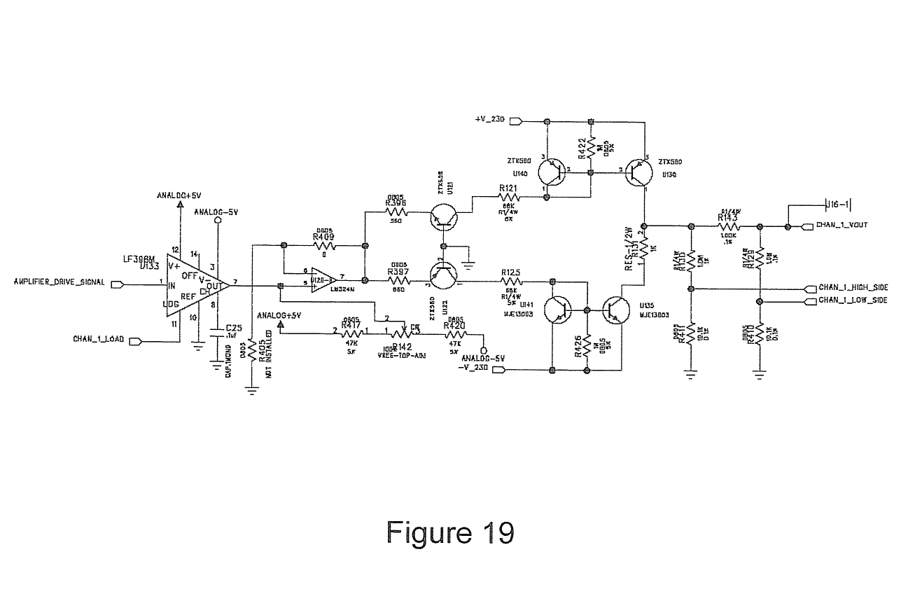

A single analog channel is shown in FIG. 19. Part number LM398F is the sample and hold component for the channel. The voltage applied to this part is refreshed 4 times per second. The next component, LM324N, is an operational amplifier. This part compares the voltages on the positive (+) and negative (−) input pins. The operational amplifier output voltage is the difference between the two terminals multiplied by a large gain. The operational amplifier is configured as a voltage follower, meaning that its output voltage is equal to the voltage that is applied to its positive input (i.e., the sample and hold output voltage). The voltage follower configuration is achieved by connecting the output of the operational amplifier directly (through a zero Ohm resistor) to its negative input.

Transistors U121 and U122 are used to determine which “rail” is supplied to the channel. The +225 V rail is controlled by U121 and the −225 V rail is controlled by U122. Both components can be in the “off” state thereby disconnecting both the positive and negative rails from the output of the circuit.

The base of each of these transistors is connected to circuit common. Due to this configuration, U122 will be in the active region when the sample and hold voltage is greater than the base to emitter knee voltage of the transistor (typically 0.65 V). U121 will be in the active region when the sample and hold voltage is less than the base to emitter knee voltage. Referring to the circuit in FIG. 19, we see that a 560 Ohm resistor (R398 for U121 and R397 for U122) is in series with the voltage to the base of the transistor. Therefore we can determine the relationship between the collector current on the transistor and the output voltage of the sample and hold (Vₛₕ) as follows:

$${I}_{collector} = \frac{\vert {V}_{sh} \vert - {V}_{be}}{560 ohms} \qquad [ 1 ]$$

Note that Equation (1) is an approximation in that it assumes that the gain of the transistor is sufficiently high such that the base current contribution can be neglected.

The second stage of the analog circuit is a “current-mirror” using U140 and U139 on the positive rail and U141 and U135 on the negative rail. The two current mirror transistors on each rail (i.e., U139 and U140, or U135 and U141) are fabricated to have nearly identical characteristics and are connected such that their base to emitter voltage is equal. Therefore, the base currents of the two transistors are nearly identical. The base current of both current mirror transistors (U139 and U140, or U135 and U141) must be equal to the collector current of U121 (or U122) as this is the only path for the base current to flow (with exception to the path through the 1 M ohm resistor which is negligible in comparison). In addition, the base collector junction on U140 and U141 is shorted. This guarantees that the transistor will operate in its active region and its output collector current will be proportional to its base current. As the base current of the two current mirror transistors are equal, and as the two base currents pass through U121 (or U122), the base current of U129 (or U135) is equal to one half of the collector current calculated in Equation (1).

Given that that the sample and hold voltage (Vₛₕ) has a range of +/−2.5 volts, results in the following range of output currents:

| Sample and Hold Voltage | |
|---|---|
| (Vₛₕ) | Channel Current |
| 2.5 | (1.65 * U139 gain) mA |
| −2.5 | (−1.65 * U135 gain) mA |

To operate the PPS instrument (200), the user turns the instrument on using ON/OFF pushbutton (202) on the front panel. A green LED (203) on the front face illuminates to indicate that the instrument is on. When the instrument is turned on, the three internal power supplies are energized and the internal processors are booted.

The instrument will not operate until it is configured using the external PC and GUI software. The GUI software is used to configure and set-up a test run. Groups of sample wells are identified and assigned a test profile, which is either a controlled voltage profile or a controlled current profile. Once the test run is configured, the user opens the cover to the test chamber and inserts a cartridge loaded with the appropriate samples, and closes the cover to the instrument. The instrument includes an optional bar code scanner (260) that reads a label on the cartridge and verifies that the cartridge is valid and installed correctly. An example of a useful bar code scanner is a Symbol Corporation bar code scanner MS1207 WA. The bar code scanner is positioned so that it reads a printed bar code label affixed to the cartridge. Bar code scanner (260) communicates with the SBC via a USB port.

When a multi-well cartridge is installed, the user starts the test run from the GUI software. The test profile commands are loaded to the instrument and the test run is started. During a test run, a yellow LED (204) on the front face illuminates. Data from the test run, including applied voltage and current, are communicated from the instrument to the GUI software. The user can monitor the test run using the GUI software. At the end of the run, the GUI software indicates the test run is complete, saves the recorded data to a file, and provides a report to the user. The user opens the cover to the test chamber, removes the cartridge, and performs the necessary disassembly and post-processing steps to the capture slides.

The firmware and software operate the first and second CPU's cooperatively to control the workstation operation. Generally the current or voltage applied to each well is controllable by the operator or user. Preferably, the current or voltage applied to each well is separately controllable so that the current or voltage can be set to be either the same or different for each sample well. Also the time of application of the selected current or voltage to each well is preferably selectable, so that the operator can select a predetermined value for the electrophoretic charge passing through each sample well prior to termination of a sample run.

Alternatively, the workstation can be controlled manually to select the current, voltage, and duration of a sample run. In this embodiment, the controls are placed on the outside of the workstation instrument.

What is claimed is:

1. A cartridge comprising:
a cartridge well frame including a plurality of wells and at least one lower reservoir port;
a cartridge gel plate including a plurality of holes;
a cartridge capture slide including a plurality of holes;
a spacer including a plurality of holes wherein each hole is at least partially filled with a porous material; and
a cartridge buffer reservoir frame wherein a plurality of wells in the cartridge well frame is substantially aligned with a plurality of holes in each of the cartridge gel plate, the cartridge capture slide, and the spacer.

2. The cartridge of claim 1 wherein each of the plurality of wells of the cartridge well frame has an upper cylindrical section and a lower conical section.

3. The cartridge of claim 1 wherein the plurality of wells of the cartridge well frame include inlet rims.

4. The cartridge of claim 1 wherein the cartridge well frame includes an array of 96 wells and 4 lower reservoir ports.

5. The cartridge of claim 1 wherein each of the plurality of wells includes an outlet each well outlet including a raised lip seal.

6. The cartridge of claim 1 wherein the cartridge is filled with an electrolytic solution.

7. The cartridge of claim 1 wherein the plurality of holes in the cartridge gel plate are substantially filled with an analyte separation layer

8. The cartridge of claim 7 wherein the analyte separation layer is polyacrylamide gel.

9. The cartridge of claim 1 wherein the cartridge gel plate has a top side associated with the cartridge well frame and a bottom side associated with the cartridge capture slide wherein the cartridge gel plate further includes sealing ribs on bottom side.

10. The cartridge of claim 1 wherein the cartridge capture slide includes four capture slide elements.

11. The cartridge of claim 10 wherein the four capture slide elements are connected with break-away connectors.

12. The cartridge of claim 10 wherein the plurality of holes in the cartridge capture slide are smaller in diameter than the holes in the cartridge gel plate.

13. The cartridge of claim 1 wherein the spacer holes are substantially filled with a conductive electrolyte.

14. The cartridge of claim 13 wherein the spacer holes are substantially filled with agarose gel.

15. The cartridge of claim 1 wherein the cartridge buffer reservoir frame includes an electrically conductive material that electrically unites an electrolytic solution in the lower reservoir ports with the permeable material in the spacer holes.

16. The cartridge of claim 1 wherein the cartridge buffer reservoir frame includes ridges to secure the spacer in place.

17. The cartridge of claim 1 wherein the cartridge buffer reservoir frame includes a plurality of strengthening posts.

18. A cartridge comprising:
a cartridge well frame including a plurality of wells and at least one lower reservoir port each of the plurality of wells including an upper cylindrical section and a lower conical section, an inlet rim, and a well outlet including a raised lip seal;
a cartridge gel plate having a top side associated with the cartridge well frame and a bottom side, sealing ribs on bottom side, wherein each of the plurality of holes in the cartridge gel plate are substantially filled with polyacrylamide gel;
a cartridge capture slide including a plurality of holes are smaller in diameter than the holes in the cartridge gel plate, the cartridge capture slide further including four capture slide elements wherein capture slide elements are connected with break-away connectors;
a spacer including a plurality of holes wherein each hole is at least partially filled with agarose gel; and
a cartridge buffer reservoir frame including lower reservoir ports and an electrically conductive material that electrically unites an electrolytic solution in the lower reservoir ports with the permeable material in the spacer holes, and a plurality of strengthening posts;
wherein a plurality of wells in the cartridge well frame is substantially aligned with a plurality of holes in each of the cartridge gel plate, the cartridge capture slide, and the spacer.

19. The cartridge of claim 1 including an array of 96 wells and 4 lower reservoir ports.

20. An instrument comprising:
a housing; and
a test chamber located in the housing, the test chamber further including:
(i) an electrode array including a plurality of sample electrodes and at least one return electrode;
(ii) a tray for holding a cartridge, the cartridge including a plurality of sample wells and at least one lower reservoir port, the electrode array moveable towards the cartridge such that at least a plurality of the sample electrodes are located in sample wells and the at least one return electrode is located in the at least one lower reservoir port; and
a control system for controlling the application of a voltage and/or current to the plurality of sample electrodes and/or the at least one return electrode.

21. The instrument of claim 20 wherein the electrodes are platinum coated nylon pins.

22. The instrument of claim 20 wherein at least one thermal electric cooler is located below the tray.

23. The instrument of claim 20 including a nest fixture for holding the cartridge.

24. The instrument of claim 20 including at least two pins for aligning the cartridge in the test chamber.

25. The instrument of claim 20 wherein the housing includes a first central processing unit for controlling the operation of the instrument.

26. The instrument of claim 25 including a second processing unit located external to the housing and connected to the first central processing unit, the second processing unit including a user interface.

27. The instrument of claim 20 wherein the electrode array is attached to an electrode array printed circuit board.

28. The instrument of claim 27 wherein the electrode array printed circuit board is electrically associated with at least one analog circuit.

29. The instrument of claim 20 including a cover wherein the electrode array is associated with the cover.

30. The instrument of claim 26 wherein the first processing unit controls the voltage of less than all of the electrodes in the electrode array.

31. The instrument of claim 26 wherein the first processing unit controls the voltage of all of the electrodes in the electrode array.
